(19) United States
(12) Patent Application Publication
(10) Pub. No.: US 2015/0248259 A1
(43) Pub. Date: Sep. 3, 2015

(54) INFORMATION PROCESSING APPARATUS, PRINT SYSTEM, AND RECORDING MEDIUM

(71) Applicant: Shohgo KUMAGAI, Kanagawa (JP)

(72) Inventor: Shohgo KUMAGAI, Kanagawa (JP)

(73) Assignee: RICOH COMPANY, LTD., Tokyo (JP)

(21) Appl. No.: 14/632,716

(22) Filed: Feb. 26, 2015

(30) Foreign Application Priority Data
Mar. 3, 2014 (JP) 2014-040888

(51) Int. Cl. G06F 3/12; G06K 15/00; G06K 15/02

(52) U.S. Cl. CPC G06F 3/1228; G06F 3/1205; G06F 3/1206; G06K 15/1805; G06K 15/40

(57) ABSTRACT

An information processing apparatus includes a device driver part having model information including the functions of one or more devices, and support function information indicating the functions; and a model information generation unit generating second adding model information based on a comparison between first adding model information and the support function information. Further, the first adding model information includes information of functions that can be executed in a device corresponding to a model to be added, and the generated second adding model information includes information of the function of the model to be added so that the device driver part can request to use the function of the device of the model to be added.

### CROSS-REFERENCE TO RELATED APPLICATIONS

The present application is based on and claims the benefit of priority under 35 U.S.C §119 of Japanese Patent Application No. 2014-040888 filed Mar. 3, 2014, the entire contents of which are hereby incorporated herein by reference.

### BACKGROUND OF THE INVENTION

1. Field of the Invention

The present invention generally relates to an information processing apparatus, a print system, and a recording medium.

2. Description of the Related Art

A model (machine type) common printer driver, which supports plural models, has functions of displaying a user interface supporting (corresponding to) a connecting model, changing print data so as to support the connecting model, etc., by replacing plural sets of model information based on the connecting model.

Regarding such a model common printer driver, there has been known a technique in which it is possible to add a model that the model common printer driver can support by adding the support (corresponding) model information. (See, for example, Japanese Laid-open Patent Publication No. 2009-025865).

### SUMMARY OF THE INVENTION

According to an aspect of the present invention, an information processing apparatus includes a device driver part including one or more sets of model information including information of functions that can be requested to one or more devices, and support function information indicating information of the functions included in the one or more sets of model information; and a model information generation unit configured to generate second adding model information based on a comparison between first adding model information and the support function information. Further, the first adding model information includes information of functions that can be executed in a device corresponding to a model to be added; the second adding model information is used for adding the model to be added that the device driver part can support, so that the device driver part can use a function of the model to be added; and the generated second adding model information includes information of the function of the model to be added so that the device driver part can request to use the function of a device of the model to be added.

### BRIEF DESCRIPTION OF THE DRAWINGS

Other objects, features, and advantages of the present invention will become more apparent from the following description when read in conjunction with the accompanying drawings, in which:

FIG. 1 is a conceptual drawing illustrating an example print setting screen in related art;

FIG. 2 illustrates an example configuration of a print system according to a first embodiment;

FIG. 3 illustrates an example hardware configuration of a computer according to the first embodiment;

FIG. 4 illustrates an example functional block diagram of an information processing apparatus according to the first embodiment;

FIG. 5 illustrates an example functional block diagram of a printer driver according to the first embodiment;

FIG. 6 illustrates an example configuration of model information according to the first embodiment;

FIG. 7 illustrates an example support (corresponding) function list according to the first embodiment;

FIG. 8 is a flowchart of an example of a print setting screen display process according to the first embodiment;

FIG. 9 is a conceptual drawing of an example of a print setting screen;

FIG. 10 is a flowchart of an example of a support function list generation process according to the first embodiment;

FIG. 11 is an example drawing illustrating the support function list generation process;

FIG. 12 is a flowchart of an example of a model information generation process according to the first embodiment;

FIG. 13 is an example drawing illustrating the model information generation process;

FIG. 14 is a flowchart of an example of a print process according to the first embodiment;

FIG. 15 illustrates an example functional block diagram of an information processing apparatus according to a second embodiment;

FIG. 16 illustrates an example functional block diagram of a model adding application and a printer driver according to the second embodiment;

FIG. 17 is a flowchart of an example of the model information generation process according to the second embodiment;

FIG. 18 illustrates an example of model information addition by the model adding application;

FIG. 19 illustrates another example of the model information addition by the model adding application;

FIG. 20 is a flowchart of an example of the print setting screen display process according to the second embodiment;

FIG. 21 illustrates an example functional block diagram of the model adding application and the printer driver according to a third embodiment; and

FIG. 22 is a flowchart of an example of the model information generation process according to the third embodiment.

### DETAILED DESCRIPTION OF THE PREFERRED EMBODIMENTS

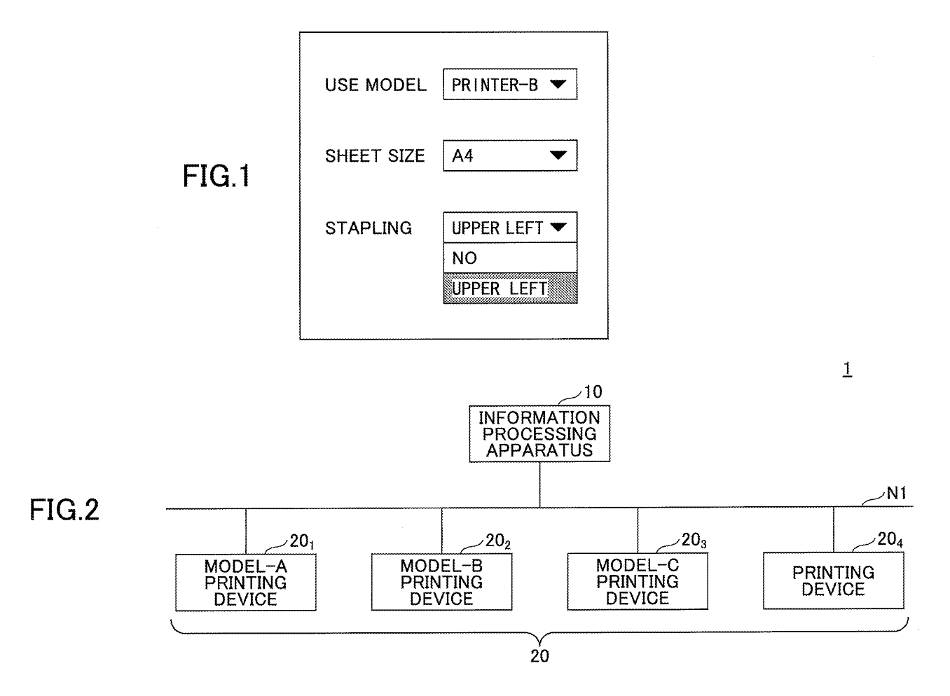

In related technologies, in a case where model information is added including a function that is not supported by a model common printer driver and a user uses the function in printing, printing in accordance with the user's intention may not be achieved. For example, in a case where the model information including a “stapling” function is added to a model common printer driver that does not support the “stapling” function so that the model information is read, the “stapling” function is displayed on the user interface (print setting screen) as illustrated in FIG. 1. However, in this case, even when the user selects the “stapling” function and performs printing, the stapling is not performed and accordingly, the printing in accordance with the user's intention may not be performed.

An embodiment of the present invention is made in light of the above problem, and may provide a an information processing apparatus, a print system, and a program in a recording medium capable of generating model information, in which the functions that cannot be executed by the device driver are excluded from the added model information.

In the following, embodiments of the present invention are described in detail with reference to the accompanying drawings.

### First Embodiment

FIG. 2 illustrates an example configuration of a print system 1 according to a first embodiment. The print system 1 in FIG. 2 includes an information processing apparatus 10 and printing device(s) 20 which are connected to each other via a wireless and/or wired network N1.

The information processing apparatus 10 is, for example, a personal computer (PC) in which a printer driver is installed. The information processing apparatus 10 may be a mobile information terminal such as a tablet terminal, a smartphone, a cellular phone, a personal digital assistant (PDA), etc., as long as a printer driver is installed therein. Further, in the information processing apparatus 10, it is assumed that an application (more specifically, a print application) that can send a print request to the printing device 20, the application including document generation software, browser software, presentation document generation software, etc. The printer driver is an example of the claimed “device driver part”.

The printing device 20 is an image forming apparatus that acquires the print request and print data (print job) from the information processing apparatus 10 and performs printing. The printing device 20 may be a Multifunction Peripheral (MFP) that has multiple functions as not only a printer but also a copier, a scanner, a facsimile machine, etc. The term “print data” herein refers to electronic data that are converted from data to be printed such as document data, image data, etc., so that the print data has a format that is interpretable by the printing device 20. The format that is interpretable by the printing device 20 includes, for example, a Page Description language (PDL). Here, it is assumed that the print system 1 of FIG. 2 includes a model-A printing device 20₁, a model-B printing device 20₂, a model-C printing device 20₃, and a model-D printing device 20₄, which are connected to each other via the network N1. In this embodiment, as described below, a case is described where model-D information is added to a printer driver that supports the model-A printing device 20₁, the model-B printing device 20₂, and the model-C printing device 20₃, so that, for example, the print setting screen for the model-D printing device 20₄ is displayed. Here, when it is not desired to distinguish the model-A printing device 20₁, the model-B printing device 20₂, the model-C printing device 20₃, and the model-D printing device 20₄ from each other, the term “printing device(s) 20” may be collectively used.

Further, the print system 1 may include two or more information processing apparatuses 10 and may include five or more printing devices 20. In a case where the print system 1 includes two or more information processing apparatuses 10, any one of the information processing apparatuses 10 may have, for example, a print server function. In this case, the information processing apparatus(es) 10 (i.e., client(s)) other than the information processing apparatus 10 having the print server function may send the print request to the printing devices 20 via the information processing apparatus 10 serving as the print server.

### Hardware Configuration

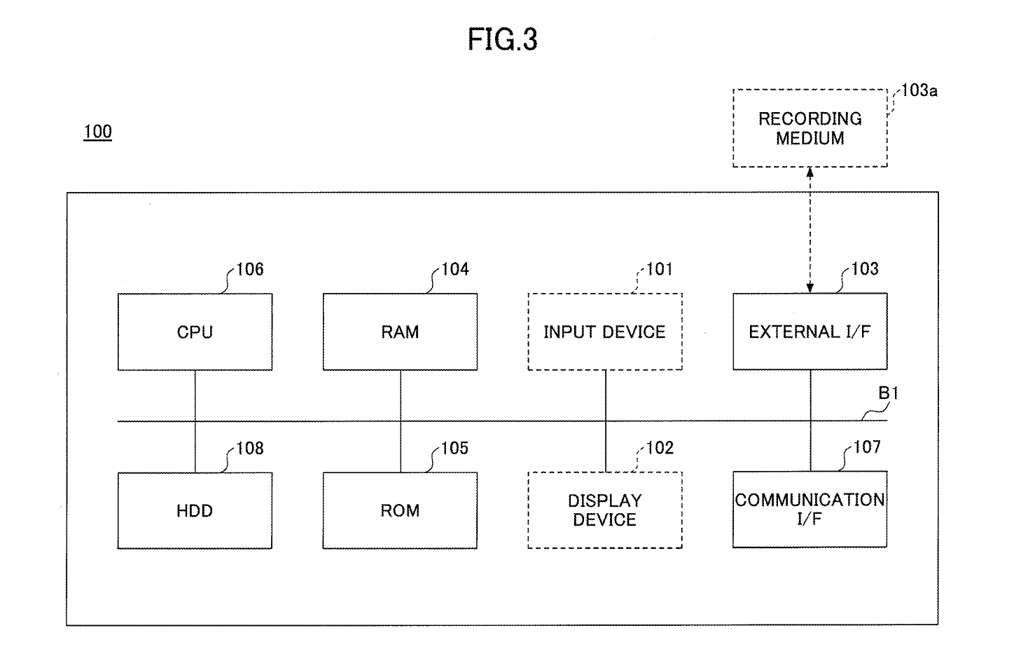

The information processing apparatus 10 according to the first embodiment is realized by a computer, etc., which has a hardware configuration as exemplarily illustrated in FIG. 3. FIG. 3 illustrates an example hardware configuration of a computer 100 according to the first embodiment. The computer 100 includes an input device 101, a display device 102, an external interface (I/F) 103, a Random Access Memory (RAM) 104, a Read-Only Memory (ROM) 105, a Central Processing Unit (CPU) 106, a communication I/F 107, and a Hard Disk Drive (HDD) 108, which are mutually connected to each other via a bus B1.

The input device 101 includes a keyboard, a mouse, a touch panel, etc., and is used to input various operation signals to the computer 100. The display device 102 includes a Liquid Crystal Display (LCD), a Cathode Ray Tube, or the like, and displays a processing result acquired by the computer 100. However, in a case where, for example, the information processing apparatus 10 is a print server, the computer 100 may not include the input device 101 and/or the display device 102.

The external I/F 103 is an interface with an external device. The external device includes a recording medium 103a, etc. Here, it is possible to store a program, which realizes an embodiment of the present invention, into the recording medium 103a. The computer 100 can read and/or write data from and/or to the recording medium 103a via the external I/F 103.

As the recording medium 103a, a Universal Serial Bus (USB) memory, an SD Memory card, a Digital Versatile Disk (DVD), a Compact Disk (CD) a Flexible Disk, etc., may be used.

The RAM 104 is a volatile semiconductor memory (storage device) to temporarily store a program and data. On the other hand, the ROM 105 is a non-volatile memory (storage device) that holds stored data even when power is cut off. The ROM 105 stores programs and data such as a Basic Input/Output System (BIOS), which is executed when the computer 100 starts up, Operating system (OS) settings, network settings, etc.

The CPU 106 is an arithmetic device that loads a program and data from a storage device such as the ROM 105, the HDD 108, etc., onto the RAM 104, and performs processing, so as to control overall of and realize the functions of the computer 100.

The communication I/F 107 is an interface to connect to a network. By having the communication I/F 107, it becomes possible for the computer 100 to perform data communications via the communication I/F 107. Further, the communications using the communication I/F 107 may be performed wirelessly or using a wire.

The HDD 108 is a non-volatile storage device that stores programs and data. The stored programs and data include, for example, the OS which is fundamental software to control overall the computer 100, application software that provides various functions running on the OS, etc. The HDD 108 manages the stored programs and data by using a predetermined file system and/or a Data Base (DB).

The information processing apparatus 10 according to the first embodiment can realize various processes described below by executing the corresponding programs on the computer 100 which has, for example, the hardware configuration described above.

### Software Configuration

### Information Processing Apparatus 10

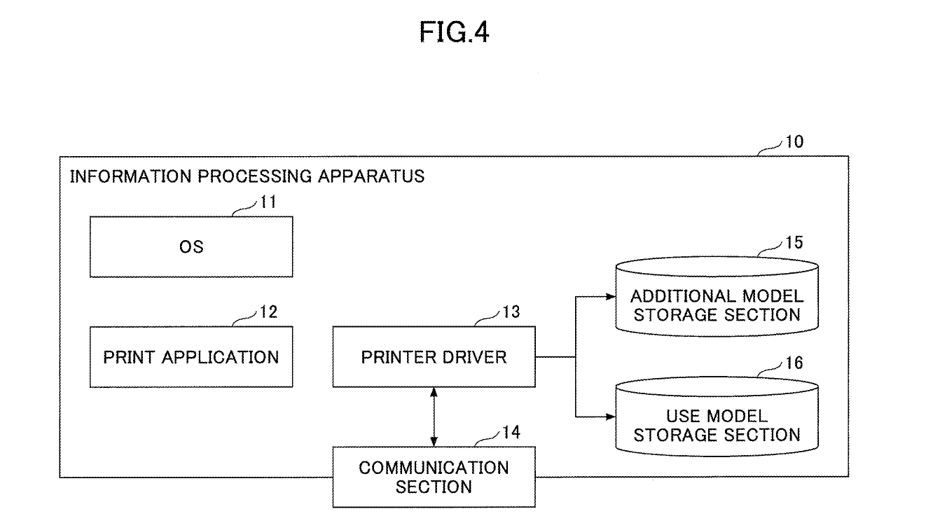

The information processing apparatus 10 according to the first embodiment is illustrated by using, for example, a functional block diagram of FIG. 4. FIG. 4 is a functional block diagram of an example of the information processing apparatus 10 according to the first embodiment.

The information processing apparatus 10 includes an OS 11, a print application 12, a printer driver 13, a communication section 14, an additional model storage section 15, and a use model storage section 16.

The OS 11 is fundamental software that controls the entire information processing apparatus 10. As the OS 11, there are Windows (registered trademark), UNIX (registered trademark), MacOS (registered trademark), etc. The print application 12 is an application that can perform (generate) print instructions on data to be printed such as document data, image data, etc. As the print application 12, there are, for example, document generation software, browser software, presentation document generation software, etc. The printer driver 13 is a printer driver (model common printer driver) that supports plural models. The printer driver 13 includes model information including models that are supported. The communication section 14 performs communications with the printing devices 20. For example, the communication section 14 transmits the print job to the printing devices 20.

The additional model storage section 15 is a storage area where the model information is stored when a (new) model to be supported is added to the printer driver 13. For example, in a case where the OS 11 is a Windows based OS, the additional model storage section 15 is a registry such as PrinterDriverData. The additional model storage section 15 may be a file system. Here the Windows based OS includes, for example, WindowsNT, Windows98, Windows2000, Windows2000 Server, Windows2003 Server, Windows2008 Server, WindowsMe, WindowsXP, WindowsVista, Windows7, Windows8, and the later versions.

Further, as described below, as an example, a case is described where one model information set (model-D model information 2000) is stored in the additional model storage section 15. However, two or more model information sets may be stored in the additional model storage section 15. Hereinafter, the model-D model information 2000 may be simplified as “model information 2000”.

The use model storage section 16 is a storage area where the model information, which is used by the printer driver 13, is stored. Namely, the printer driver 13 reads the model information stored in the use model storage section 16, so as to display the print setting screen and generates the print data. In other words, the use model storage section 16 stores the model information of the model(s) that is selected by a user from among plural models supported by the printer driver 13. For example, in a case where the OS 11 is a Windows based OS, the use model storage section 16 is a registry such as PrinterDriverData. The use model storage section 16 may be a file system.

### Printer Driver 13

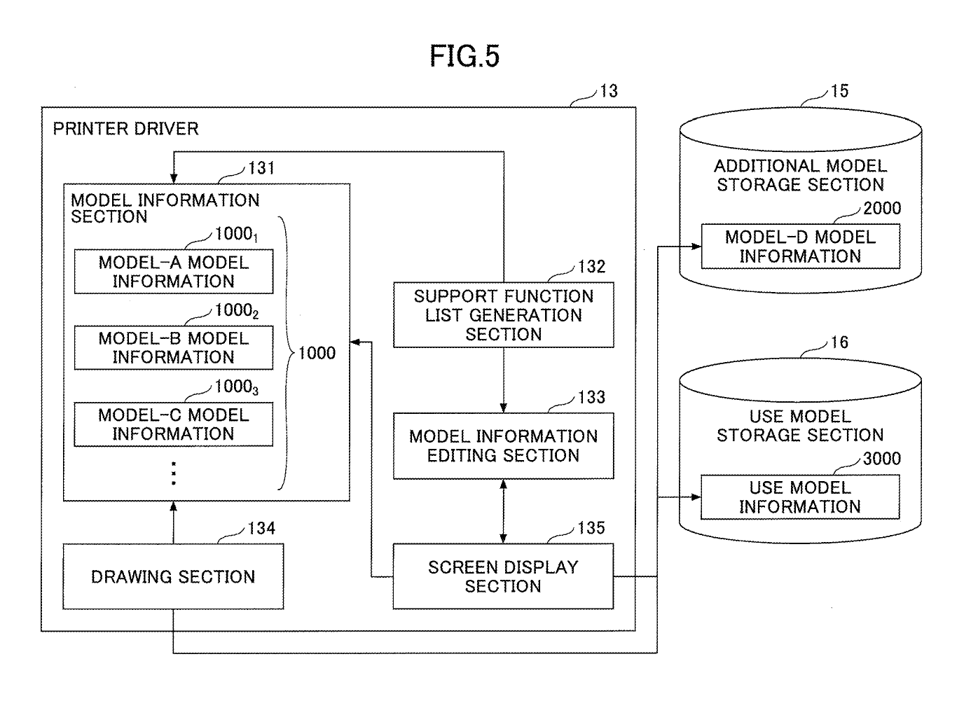

The printer driver 13 according to the first embodiment can be illustrated by, for example, the functional block diagram as illustrated in FIG. 5. FIG. 5 is a functional block diagram of an example of the printer driver 13 according to the first embodiment.

The printer driver 13 includes a model information section 131, a support (corresponding) function list generation section 132, a model information editing section 133, a drawing section 134, and a screen display section 135.

The model information section 131 is an area where model information 1000 is stored, the model information 1000 indicating models that are supported by the printer driver 13. In this embodiment, in the model information section 131, model-A model information 1000₁, model-B model information 1000₂, and model-C model information 1000₃ are stored. In other words, the printer driver 13 supports the model-A printing device 20₁, the model-B printing device 20₂, and the model-C printing device 20₃. Here, when it is not desired to distinguish the model-A model information 1000₁, the model-B model information 1000₂, the model-C model information 1000₃, etc., from each other, the term “model information 1000” may be collectively used.

The support function list generation section 132 generates a list (a support function list 4000) (see FIG. 7) of the functions supported by the printer driver 13 (i.e., the functions that are executable by the printer driver 13) based on the model information 1000 stored in the model information section 131. The support function list 4000 is an example of the claimed “support function information”.

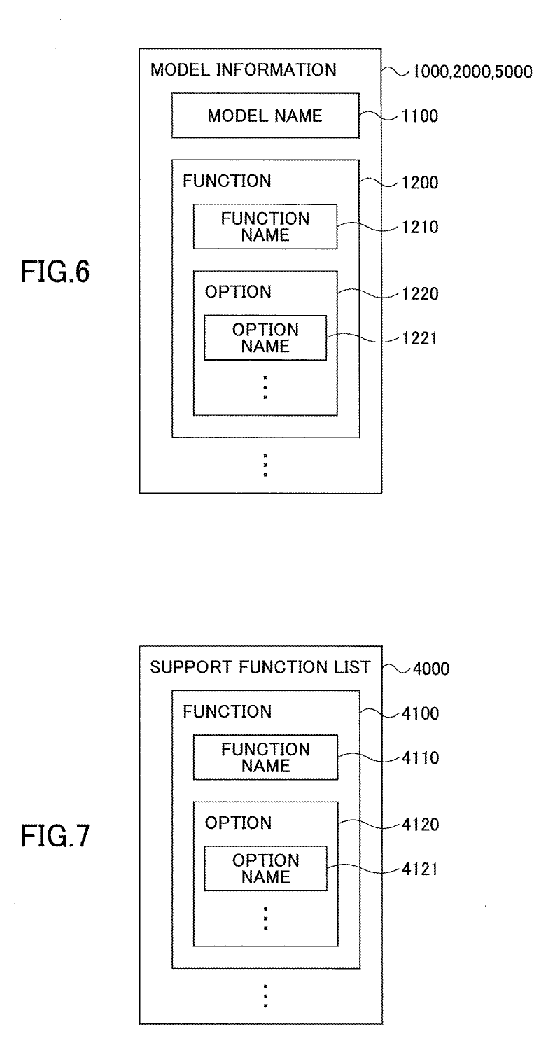

Based on the support function list 4000 and model information 2000, the model information editing section 133 generates model-D model information 5000 (see FIG. 6) (hereinafter may be simplified as “model information 5000”) which includes only the functions that are supported by the printer driver 13.

Based on the print request from the print application 12, the drawing section 134 generates the print data from the data to be printed. Further, in this case, the drawing section 134 acquires the model information 1000 or the model information 2000 from the model information section 131 or the additional model storage section 15, so as to generate the print data based on the acquired model information 1000 or the model information 2000. Further, the drawing section 134 determines which of the model information 1000 or the model information 2000 is to be acquired, based on use model information 3000 that is stored in the use model storage section 16. Namely, the drawing section 134 acquires the model information same as the model information of the use model information 3000 from the model information 1000 or the model information 2000.

The screen display section 135 displays the print setting screen. In this case, the screen display section 135 generates the print setting screen based on the model information 1000 stored in the model information section 131 or the model information 5000 generated by the model information editing section 133, and displays the generated print setting screen. Here, the screen display section 135 determines which of the model information is to be used, based on the use model information 3000 stored in the use model storage section 16. Namely, the screen display section 135 generates the print setting screen based on the model information 1000 or the model information 5000 having the model same as the model of the use model information 3000.

### Model Information

For example, the model information 1000, the model information 2000, and the model information 5000 according to the first embodiment have a configuration as illustrated in FIG. 6. FIG. 6 illustrates an example configuration of the model information according to the first embodiment. In the following, the model information 1000 is exemplarily described.

The model information 1000 includes data items such as a model name 1100, one or more functions 1200, etc. The function 1200 includes data items such as a function name 1210, a choice 1220, etc. The choice 1220 includes data items such as a choice name 1221, etc.

The model name 1100 is a model name of the printing device 20 that is supported by the printer driver 13 by reading the model information 1000. The model name 1100 is, for example, a model-A, a model-B, a model-C, a model-D, etc.

For example, the function 1200 includes the function name 1210 such as “sheet size” and the corresponding choice 1220 including the choice names 1221 such as “A4”, “B5”, etc. By having this, for example, a user can perform the print setting by selecting the “A4”, “B5” or the like of the choice 1220. Further, as the functions 1200, there are, for example, “stapling”, “color/monochrome”, “double-sided/one-sided”, etc.

The use model information 3000 may have the configuration same as the configuration of the model information 1000 or the like. The use model information 3000 includes at least the information of the model name 1100.

The model information 1000, the model information 2000, the use model information 3000, and the model information 5000 can be described in a text format, a binary format, an Extensible Markup Language (XML) format, etc.

### Support Function List 4000

For example, the support function list 4000 according to the first embodiment has a configuration as illustrated in FIG. 7. FIG. 7 illustrates an example configuration of the support function list 4000 according to the first embodiment.

The support function list 4000 includes data items such as one or more functions 4100, etc. The function 4100 includes data items such as a function name 4110 and a choice 4120. The choice 4120 includes one or more choice names 4121, etc.

The function 4100, the function name 4110, the choice 4120, and the choice name 4121, are similar to the function 1200, the function name 1210, the choice 1220, and the choice name 1221, respectively. Therefore, the repeated descriptions thereof are herein omitted.

The support function list 4000 can be described in the text format, the binary format, the XML format, etc.

### Details of Processing

Next, details of the processing performed by the print system 1 according to the first embodiment are described.

First, in this embodiment, as described above, it is assumed that the printer driver 13 supports the model-A printing device 20₁, the model-B printing device 20₂, and the model-C printing device 20₃. Namely, the model information section 131 of the printer driver 13 includes the model-A model information 1000₁, the model-B model information 1000₂, and the model-C model information 1000₃. Further, it is assumed that the model information 2000 is added to the additional model storage section 15 of the information processing apparatus 10 by a user using, for example, an installer of the printer driver 13. By doing this, the printer driver 13 supports the model-D printing device 20₄. Further, as described below, it is further assumed that the model information 2000 includes a function that is not supported by the printer driver 13 (i.e., a function that cannot be executed by the printer driver 13). In other words, there is a function, that cannot be executed by the printer driver 13 as the function 1200 described, for example, with reference to FIG. 6, in the model information 2000.

### Print Setting Screen Display Process

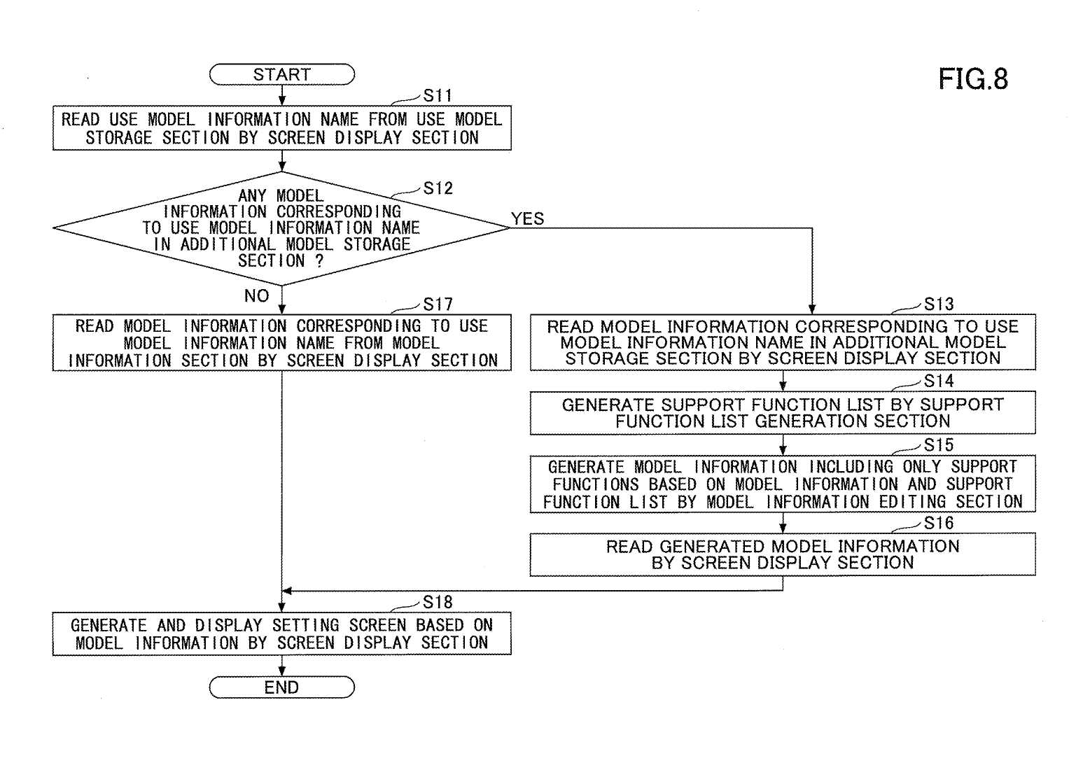

Next, a process of displaying the print setting screen by reading the model information by the printer driver 13 by an operation of a user is described. FIG. 8 is a flowchart of an example print setting screen display process according to the first embodiment.

First, it is assumed that a user performs an operation to display the print setting screen. To that end, for example, a user may open the property of the printer driver 13 from the folder where the printer driver 13 is stored, or may perform a print setting operation in the print application 12.

In step S11, the screen display section 135 acquires the use model information 3000 from the use model storage section 16. Here, the use model information 3000 includes at least the model name of the printing device 20 that is currently selected by the user.

In step S12, the screen display section 135 determines whether the model information 2000, which has the model name corresponding to the model name included in the use model information 3000, is stored in the additional model storage section 15. When it is determined that model information 2000 having the corresponding model name is stored in the additional model storage section 15, the process goes to step S13. Otherwise, the process goes to step S17.

In step S13, the screen display section 135 acquires the model information 2000, which has the model name corresponding to the model name included in the use model information 3000, from the additional model storage section 15. For example, in a case where the model name included in the use model information 3000 is the “model-D”, the screen display section 135 acquires the model information 2000 from the additional model storage section 15.

In step S14, the support function list generation section 132 generates the support function list 4000. Details of the process in step S14 are described below.

In step S15, the model information editing section 133 generates the model information 5000 that includes only the function(s), which is supported by the printer driver 13, based on the model information 2000 and the support function list 4000. Details of the process in step S15 are described below.

In step S16, the screen display section 135 reads the model information 5000.

In step S17, the screen display section 135 acquires and reads the model information 1000, which has the model name corresponding to the model name included in the use model information 3000, from the model information section 131. For example, in a case where the model name included in the use model information 3000 is “model-A”, the screen display section 135 acquires and reads the model-A model information 1000₁ from the model information section 131.

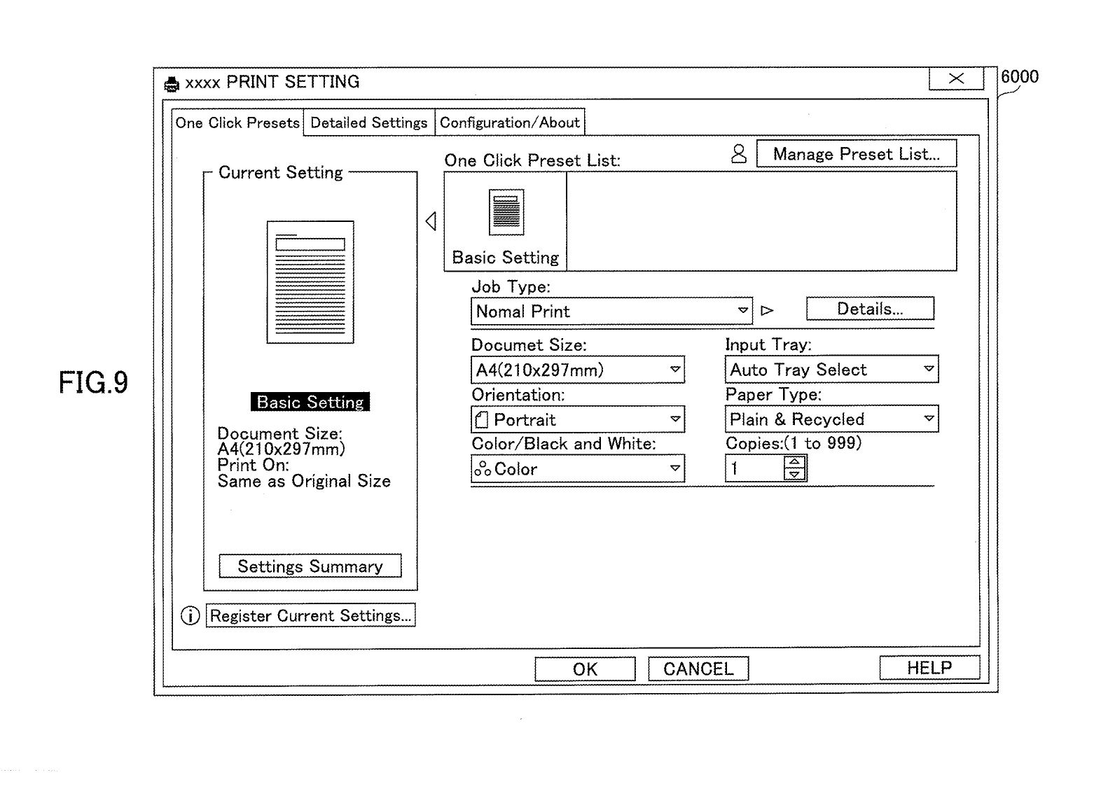

In step S18, the screen display section 135 generates the print setting screen based on the model information 1000 or the model information 5000 read in steps S16 or S17, and displays the print setting screen. In this case, the displayed print setting screen is, for example, the print setting screen 6000 as illustrated in FIG. 9. In the print setting screen 6000, there are, for example, the print setting items such as the “sheet size”, “color/monochrome”, etc., so that the user can select/change the content of the print setting items.

By doing the above, it becomes possible for the information processing apparatus 10 of the print system 1 according to the first embodiment to display the print setting screen including only the functions that are supported by the printer driver 13. For example, in a case where the printer driver 13 cannot support (execute) the “stapling” function in the information processing apparatus 10, the print setting item related to the “stapling” is not displayed in the print setting screen. By doing this, it become possible to prevent the print setting item that is not supported by (does not correspond to) the printer driver 13 from being displayed. As a result, it becomes possible to prevent the execution of the printing that is not in accordance with the user's intention.

### Support Function List Generation Process

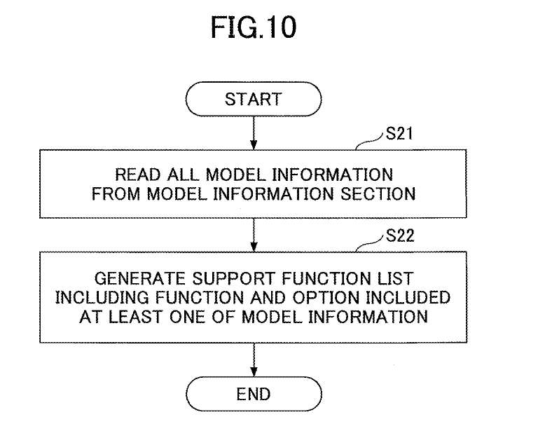

Next, the process of generating the support function list 4000 in step S14 of FIG. 8 is described. FIG. 10 is a flowchart of an example of the support function list generation process according to the first embodiment.

In step S21, the support function list generation section 132 acquires all the model information 1000 stored in the model information section 131 from the model information section 131. Namely, for example, in a case where the model-A model information 1000₁, the model-B model information 1000₂, and the model-C model information 1000₃ are stored in the model information section 131, the support function list generation section 132 acquires all the three model information sets.

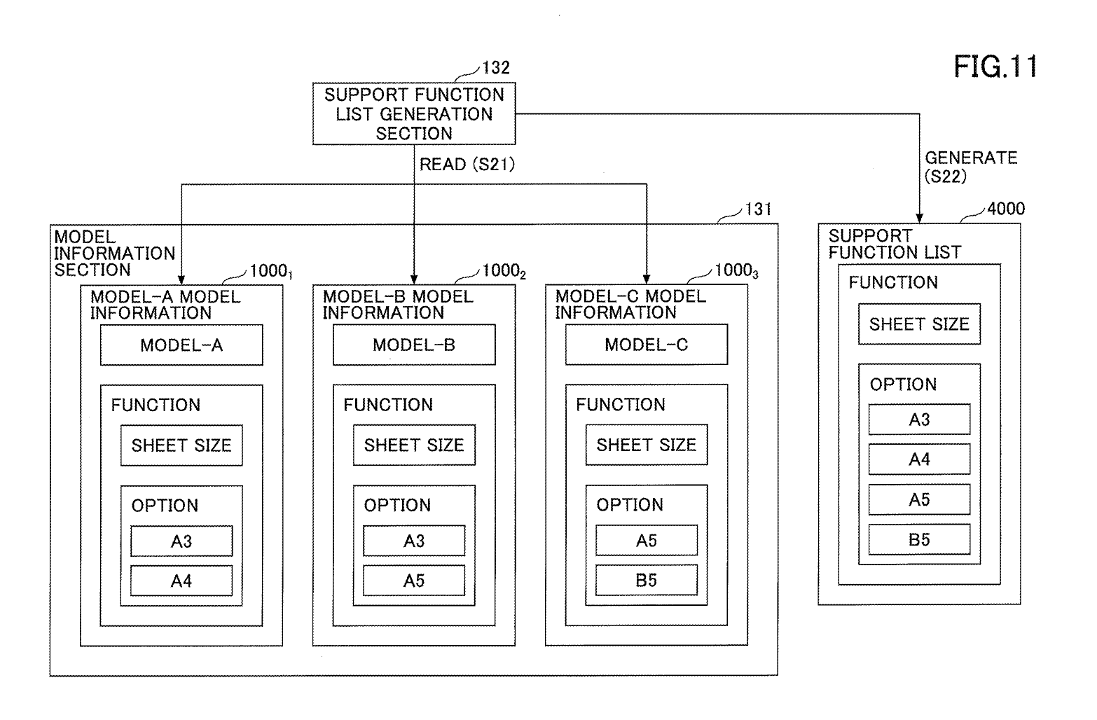

In step S22, the support function list generation section 132 generates the support function list 4000 including the functions and the choices which are included in at least one set of model information 1000 of all the model information 1000 acquired in step S21. Namely, for example, as illustrated in FIG. 11, in a case where the model-A model information 1000₁ includes “sheet size” as the function and “A3” and “A4” as the corresponding choices, the model-B model information 1000₂ includes “sheet size” as the function and “A3” and “A5” as the corresponding choices, and the model-C model information 1000₃ includes “sheet size” as the function and “A5” and “B5” as the corresponding choices, the support function list generation section 132 generates the support function list 4000 that includes the function “sheet size” and the corresponding choices “A3”, “A4”, “A5”, and “B5”. In other words, the support function list 4000 is a list of the functions that the printer driver 13 can cause the printing device 20 to execute.

Further, as illustrated in FIG. 8, the support function list 4000 is generated whenever a user displays the print setting screen corresponding to the printing device 20 of the model corresponding to the model information 2000 stored in the additional model storage section 15 (i.e., the printing device 20 corresponding to the added model). In this regard, for example, after the support function list 4000 is generated first, the support function list 4000 may be stored in a designated storage area, so that the support function list 4000 can be acquired from the designated storage area later. Otherwise, for example, the support function list 4000 may be stored in the printer driver 13 in advance.

### Model Information Generation Process

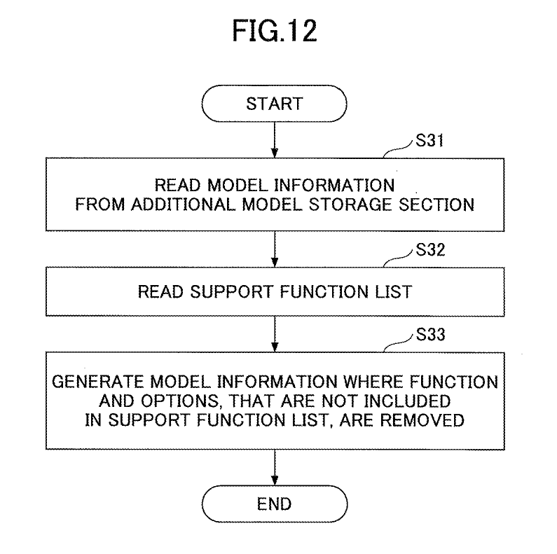

Next, the process of generating the model information 5000 in step S15 of FIG. 8 is described. FIG. 12 is a flowchart of an example of the model information generation process according to the first embodiment.

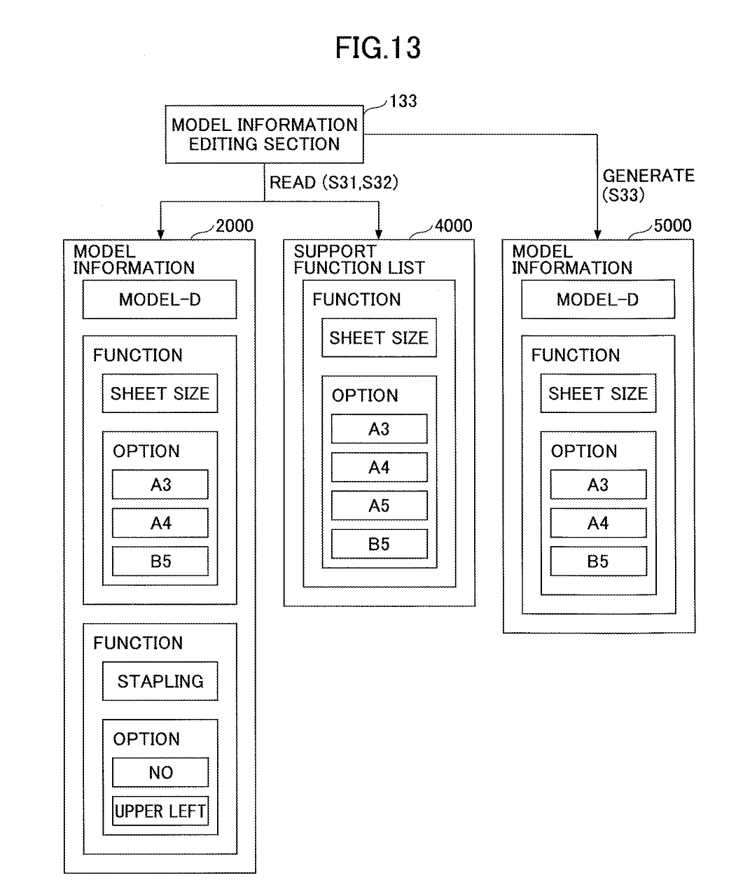

In step S31, the model information editing section 133 acquires the model information 2000 from the additional model storage section 15. In step S32, the model information editing section 133 acquires the support function list 4000 generated in step S14 of FIG. 8. Namely, for example, as illustrated in FIG. 13, the model information editing section 133 acquires and reads the model information 2000 and the support function list 4000.

In step S33, the model information editing section 133 generates the model information 5000 based on the model information 2000 and the support function list 4000. Namely, for example, as illustrated in FIG. 13, in a case where the model information 2000 includes the function “sheet size” and the corresponding choices “A3”, “A4”, and “B5” and the function “stapling” and the corresponding choices “No” and “upper left”, the model information editing section 133 generates the model information 5000 that has the function “sheet size” and the corresponding choices “A3”, “A4”, and “B5”. In other words, the model information 5000 is generated in a manner so that the function and the choices that are included in the model information 2000 but are not included in the support function list 4000 are excluded. Accordingly, the function (and the corresponding choices) included in the model information 5000 are the functions that the printer driver 13 supports (the functions that can be executed by the printer driver 13).

Therefore, as descried above, the printer driver 13 generates the print setting screen based on the model information 1000 or the model information 5000 and displays the print setting screen. By doing this, it becomes possible to prevent the function that is not supported by the printer driver 13 from being displayed on the print setting screen. Accordingly, it becomes possible to prevent, for example, the print setting of the function that is not supported by the printer driver 13, so as to prevent the printing that is not in accordance with the user's intention.

### Print Process

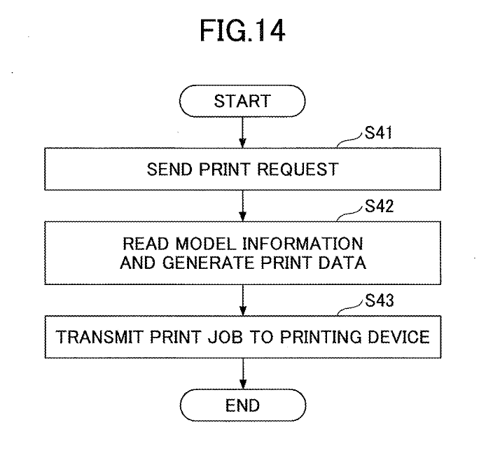

Next, the process of printing the data to be printed is described. FIG. 14 is a flowchart of an example of the print process according to the first embodiment.

In step S41, a user sends a print request to print the data to be printed from the print application 12.

In step S42, the drawing section 134 acquires the model information 1000 or the model information 2000 from the model information section 131 or the additional model storage section 15. Based on the acquired model information 1000 or the model information 2000, the drawing section 134 generates the print data from the data to be printed. In this case, the drawing section 134 refers to the use model information 3000 stored in the use model storage section 16, and acquires the model information 1000 or the model information 2000 having the model name corresponding to the model name included in the use model information 3000.

In step S43, the drawing section 134 transmits the print request and the print data (print job) to the printing device 20 of the model corresponding to the model information acquired in step S42.

By executing the above steps, it becomes possible to perform printing on the data to be printed. Further, all the processes in steps S41 through S43 may be performed by one information processing apparatus 10. Otherwise, for example, the process in step S41 may be performed by an information processing apparatus 10 which serves as a client, and the processes in steps S42 and S43 may be performed by an information processing apparatus 10 which serves as a server (the print server) (i.e., server-side rendering). Otherwise, the process in steps S41 and S42 may be performed by the information processing apparatus 10 which serves as the client, and the process in step S43 may be performed by the information processing apparatus 10 which serves as the server (the print server) (i.e., client-side rendering).

### Second Embodiment

Next, a print system 1 according to a second embodiment is described. In the print system 1 according to the second embodiment, the software configuration of the information processing apparatus 10 differs from that in the first embodiment. Here, the system configuration and the hardware configuration of the print system 1 according to the second embodiment are similar to those in the first embodiment. Therefore, the repeated description thereof are omitted.

### Software Configuration

### Information Processing Apparatus 10

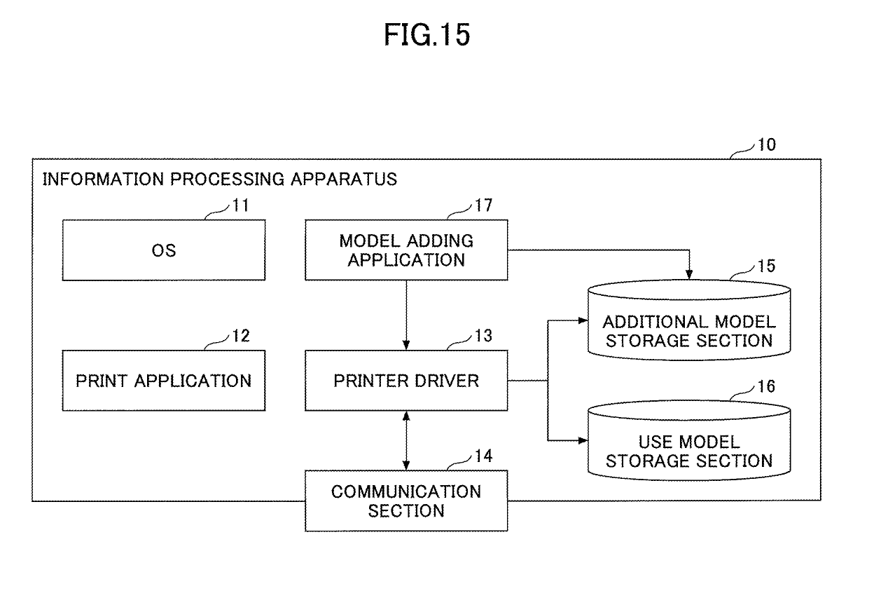

The information processing apparatus 10 according to the second embodiment can be illustrated in the functional block diagram as exemplarily illustrated in FIG. 15. FIG. 15 is a functional block diagram of an example of the information processing apparatus 10 according to the second embodiment.

The information processing apparatus 10 includes the OS 11, the print application 12, the printer driver 13, the communication section 14, the additional model storage section 15, the use model storage section 16, and a model adding application 17.

The model adding application 17 is an application that adds the model to be supported to the printer driver 13. Namely, model adding application 17 is an application for adding the model information to the additional model storage section 15. Further, the model adding application 17 acquires the model information 1000 from the printer driver 13, and generates the support function list 4000.

Further, the print application 12, the printer driver 13, the communication section 14, the additional model storage section 15, and the use model storage section 16 of the information processing apparatus 10 according to the second embodiment are similar to those in the first embodiment. Therefore, the repeated descriptions thereof are herein omitted. Further, as described below, in the second embodiment, it is not the model information 2000 but the model information 5000 that is the model information where the functions that cannot be executed by the printer driver 13 are excluded from the model information 2000 that is stored in the additional model storage section 15.

### Printer Driver 13, Model Adding Application 17

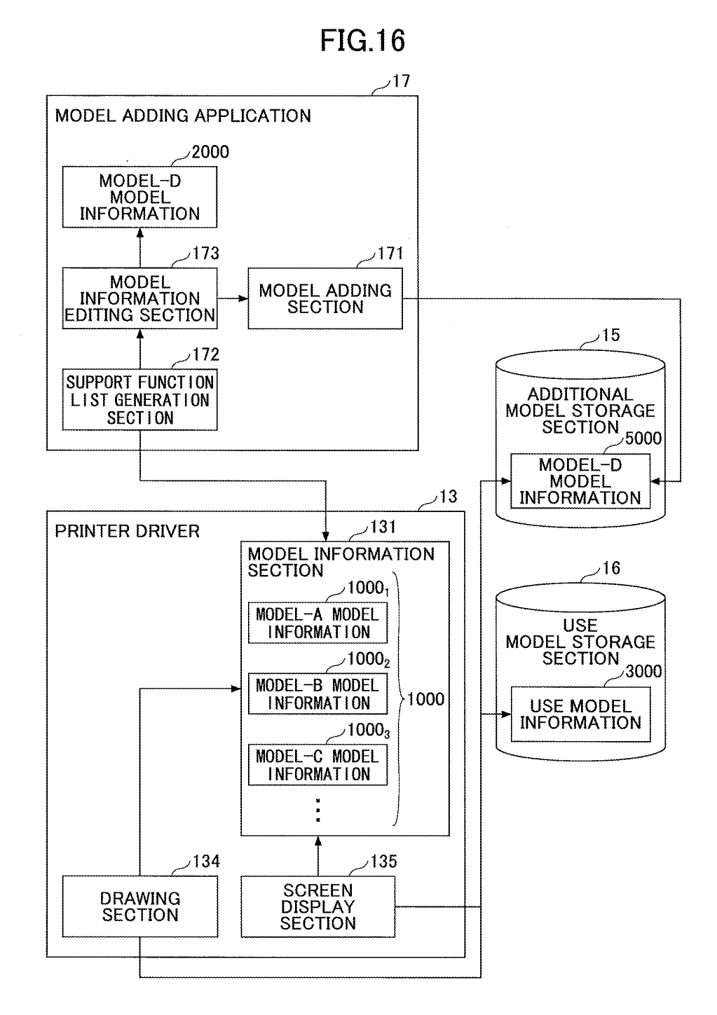

The printer driver 13 and the model adding application 17 according to the second embodiment can be illustrated by, for example, the functional block diagram as illustrated in FIG. 16.

The model adding application 17 includes a model adding section 171, a support function list generation section 172, a model information editing section 173, and the model information 2000. The printer driver 13 includes the model information section 131, the drawing section 134, and the screen display section 135.

The model adding section 171 adds the model information 5000 to the additional model storage section 15. Here, the model information 5000 in this embodiment is similar to the model information 5000 in the first embodiment. Namely, the model information 5000 in this embodiment is generated from the model information 2000 by excluding the function and the choices that are not included in the support function list 4000 from the model information 2000. Further, the model information 2000 in the second embodiment is similar to the model information 2000 in the first embodiment.

The support function list generation section 172 and the model information editing section 173 in this embodiment are similar to the support function list generation section 132 and the model information editing section 133 in the first embodiment. Therefore, the repeated descriptions thereof are omitted.

### Details of the Processes

Next, details of the processes performed by the print system 1 according to the second embodiment are described. However, the processes that are not described herein are similar to those in the first embodiment. Therefore, the repeated descriptions thereof are omitted.

### Model Information Adding Process

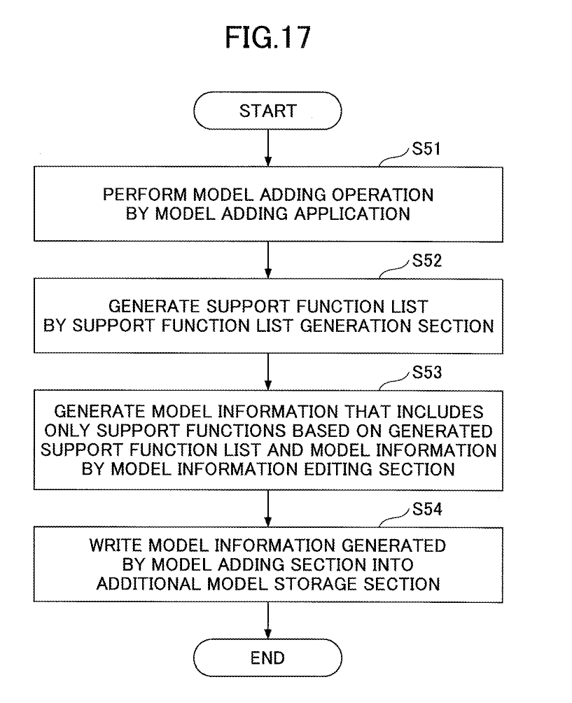

Next, the process of adding the model information 5000 to the additional model storage section 15 by using the model adding application 17 is described. FIG. 17 is a flowchart of an example of the model information adding process according to the second embodiment.

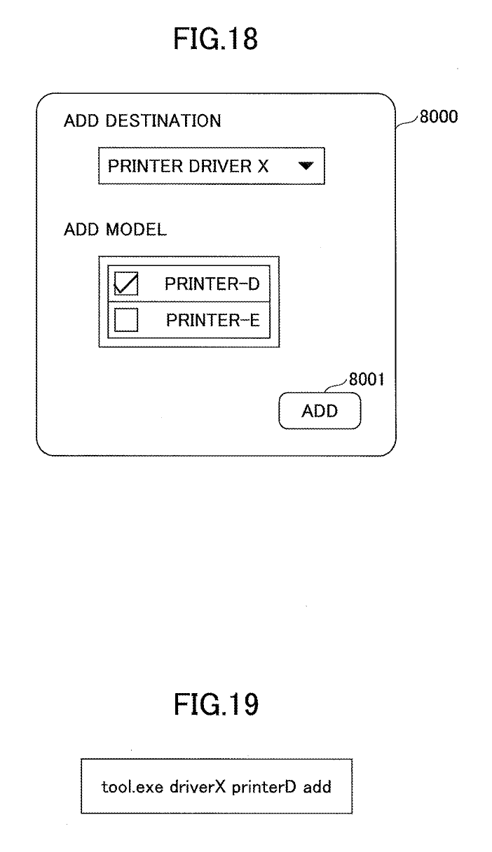

In step S51, a user uses the model adding application 17 to perform a model adding operation. To that end, for example, the user may start up the model adding application 17 to display the screen as illustrated in FIG. 18, selects (checks) “printer “D”” as the model to be added (added model), and presses the “add” button 8001. Otherwise, for example, the user may input a command as illustrated in FIG. 19 on a character-based User Interface (CUI) screen such as a command line of the OS 11. Here, the “tool.exe” is a file name of the execution file of the model adding application 17.

In step S52, the support function list generation section 172 acquires the model information 1000 from the model information section 131 of the printer driver 13, and generates the support function list 4000. The process of generating the support function list 4000 by the support function list generation section 172 is similar to the process of generating the support function list 4000 by the support function list generation section 132.

In step S53, the model information editing section 173 generates the model information 5000 based on the model information 2000 and the support function list 4000. The process of generating the model information 5000 by the model information editing section 173 is similar to the process of generating the model information 5000 by the model information editing section 133.

In step S54, the model adding section 171 adds (stores) the model information 5000 to (in) the additional model storage section 15.

By doing this, it becomes possible to add the model information 5000 to the additional model storage section 15 of the information processing apparatus 10 according to the second embodiment, so that it becomes possible for the printer driver 13 to, for example, display the print setting screen based on the model-D which is the model corresponding to the model information 5000.

### Print Setting Screen Display Process

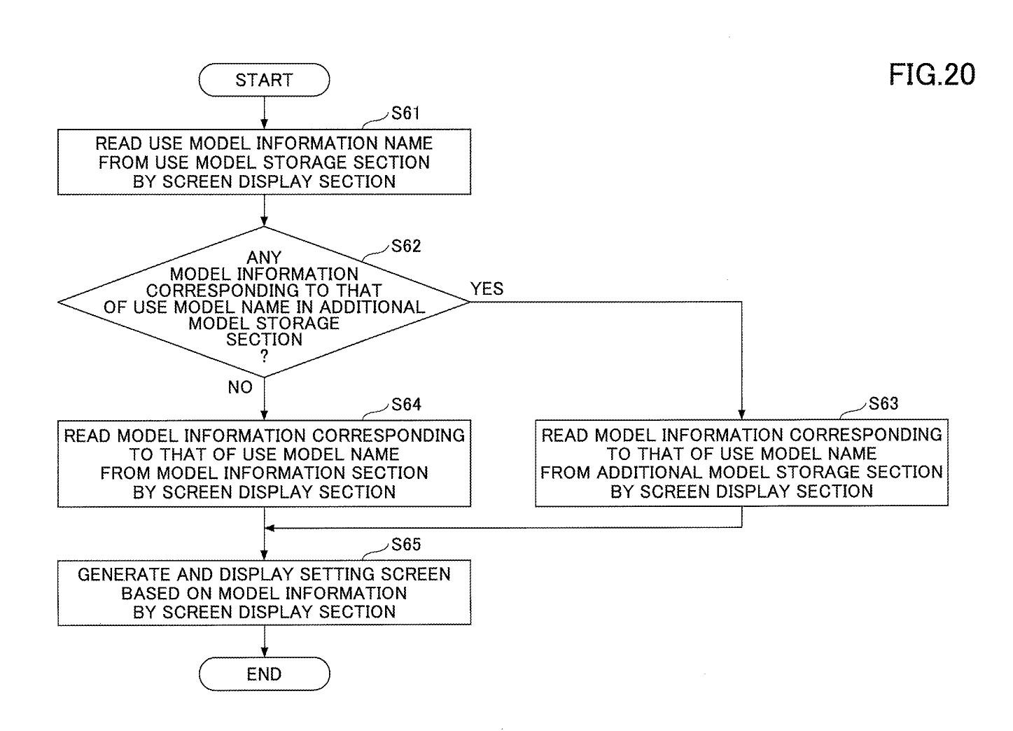

Next, a process of displaying the print setting screen according to the second embodiment is described. FIG. 20 is a flowchart of an example print setting screen display process according to the second embodiment.

The processes in steps S61 and S62 are similar to the processes in steps S11 and S12 of FIG. 8. Therefore, the repeated descriptions thereof are omitted.

In step S63, the screen display section 135 reads the model information 5000 from the additional model storage section 15.

The processes in steps S64 and S65 are similar to the processes in steps S17 and S18 of FIG. 8. Therefore, the repeated descriptions thereof are omitted.

By doing this, it becomes possible for the information processing apparatus 10 of the print system 1 according to the second embodiment to display the print setting screen corresponding to only the functions that are supported by the printer driver 13. Further, unlike the first embodiment, in the print setting screen display process according to the second embodiment, it is not necessary to generate the model information 5000 whenever the print setting screen is displayed; thereby enabling reducing the process (workload) of the printer driver 13.

### Third Embodiment

Next, a print system 1 according to a third embodiment is described. In the print system 1 according to the third embodiment, the software configurations of the printer driver 13 and the model adding application 17 differ from those in the second embodiment. However, the system configuration and the hardware configuration of the print system 1 according to the third embodiment are similar to those in the second embodiment. Therefore, the repeated descriptions thereof are herein omitted. Software configuration

### Printer Driver 13, Model Adding Application 17

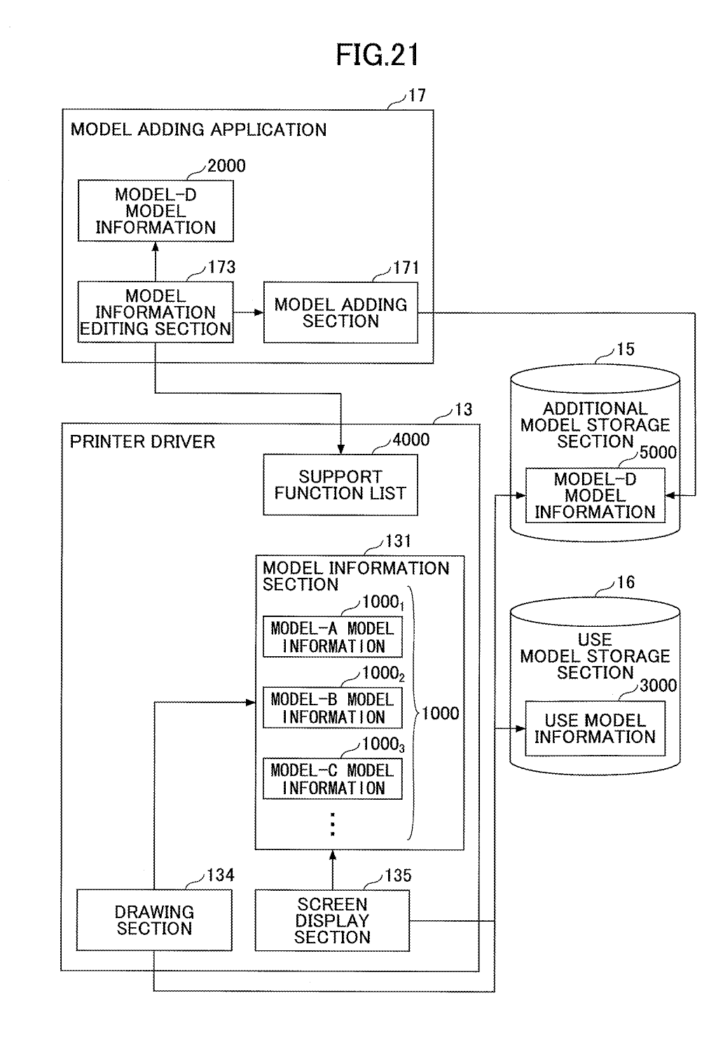

The printer driver 13 and the model adding application 17 according to the third embodiment can be illustrated by, for example, the functional block diagram as illustrated in FIG. 21.

The printer driver 13 includes the model information section 131, the drawing section 134, and the screen display section 135. Unlike the printer driver 13 in the second embodiment, the printer driver 13 in the third embodiment includes the support function list 4000 in a predetermined storage area.

The model adding application 17 includes the model adding section 171, the model information editing section 173, and the model information 2000. Unlike the model adding application 17 in the second embodiment, the model adding application 17 in the third embodiment does not include the support function list generation section 172.

The functions of the above elements of the printer driver 13 and the model adding application 17 in the third embodiment are similar to those in the second embodiment. Therefore, the repeated descriptions thereof are omitted.

### Details of the Processes

Next, details of the processes performed by the print system 1 according to the third embodiment are described. However, the processes that are not described herein are similar to those in the second embodiment. Therefore, the repeated descriptions thereof are omitted.

### Model Information Adding Process

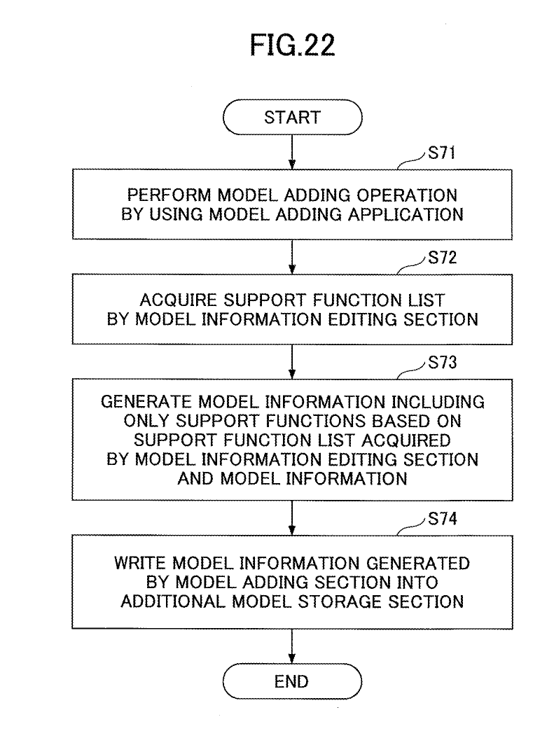

The process of adding the model information 5000 to the additional model storage section 15 by using the model adding application 17 is described. FIG. 22 is a flowchart of an example of the model information adding process according to the third embodiment.

The process in step S71 is similar to the process in step S51 of FIG. 17. Therefore, the description thereof is omitted. In step S72, the model information editing section 173 acquires the support function list 4000 from the printer driver 13.

The processes in steps S73 and S74 are similar to the processes in steps S53 and S54 of FIG. 17. Therefore, the descriptions thereof are omitted.

By doing this, the model information 5000 is added to the additional model storage section 15 of the information processing apparatus 10 according to the third embodiment, so that it becomes possible for the printer driver 13 to, for example, print by the printing device 20 and display the print setting screen in accordance with the model-D which corresponds to the model information 5000. In this case, in the information processing apparatus 10 according to the third embodiment, it is not necessary to generate the support function list 4000 because the support function list 4000 is acquired from the printer driver 13 by using the model adding application 17.

### SUMMARY

As described above, in the information processing apparatus 10 of the print system 1 according to the first embodiment, the printer driver 13 generates the support function list 4000. Further, based on the support function list 4000, the model information 5000 is generated by excluding (removing) the functions that are not be supported by the printer driver 13 from the model information 2000. Therefore, it becomes possible for the printer driver 13 to display the print setting screen of only the functions that are supported by the printer driver 13 by using the model information 5000. As a result, it becomes possible to prevent the printing in an unintended manner (which is not in accordance with user's intention) which is performed by the print setting, by a user, of the function that is not supported by the printer driver 13.

Further, in the information processing apparatus 10 of the print system 1 according to the second embodiment, the generation of the support function list 4000 and the generation of the model information 5000 are performed by the model adding application 17. By doing this, it becomes no longer necessary to implement the function of generating the support function list 4000 and the model information 5000 in the printer driver 13. Further, the model information 5000 storing only the functions that are supported by the printer driver 13 are stored in the additional model storage section 15 of the information processing apparatus 10. Therefore, it is no longer necessary to generate the model information 5000 whenever the print setting screen is displayed.

Further, in the information processing apparatus 10 of the print system 1 according to the third embodiment, the printer driver 13 stores the support function list 4000 in advance. Therefore, it is no longer necessary for the model adding application 17 to generate the support function list 4000. Accordingly, it is not necessary to implement the process of generating the support function list 4000 into the model adding application 17.

Further, the support function list generation section 132 is an example of the claimed “support function information generation unit”, the model adding section 171 is an example of the claimed “model information adding unit”, the model information editing section 133 is an example of the claimed “model information generation unit”, the screen display section 135 is an example of the claimed “display unit”, and the drawing section 134 is an example of the claimed “conversion unit” and the “print unit”.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing apparatus comprising:
a device driver part including
one or more sets of model information including information of functions that can be requested to one or more devices, and
support function information indicating information of the functions included in the one or more sets of model information; and
a model information generation unit configured to generate second adding model information based on a comparison between first adding model information and the support function information,
wherein the first adding model information includes information of functions that can be executed in the device corresponding to a model to be added,
wherein the second adding model information is used for adding the model to be added that the device driver part can support, so that the device driver part can use a function of the model to be added, and
wherein the generated second adding model information includes information of the function of the model to be added so that the device driver part can request to use the function of the device of the model to be added.

2. The information processing apparatus according to claim 1, further comprising:
a support function information generation unit configured to generate the support function information based on the one or more sets of model information included in the device driver part, the support function information indicating information of the functions that can be requested by the device driver part.

3. The information processing apparatus according to claim 1,
wherein the model information generation unit is configured to generate the second adding model information by comparing the first adding model information and the support function information and excluding information of functions that are not included in the support function information from information of functions that the device of the model to be added, included in the first adding model information, can execute.

4. The information processing apparatus according to claim 1, further comprising:
a display unit configured to display a setting screen of the device selected by a user,
wherein the display unit is configured to display the setting screen in accordance with the model information or the second adding model information based on the model information or the second adding model information.

5. The information processing apparatus according to claim 1, further comprising:
a conversion unit configured to convert a data format of electronic data into a data format in accordance with the device selected by a user,
wherein the conversion unit is configured to convert the data format of the electronic data into a data format in accordance with the model information or the second adding model information based on the model information or the second adding model information.

6. The information processing apparatus according to claim 1,
wherein a data format of the model information and/or the second adding model information is a text format.

7. The information processing apparatus according to claim 1,
wherein a data format of the model information and/or the second adding model information is a binary format.

8. The information processing apparatus according to claim 1, further comprising:
a model information adding unit configured to store the second adding model information generated by the model information generation unit into a predetermined storage area.

9. A non-transitory recording medium storing a program causing an information processing apparatus including a device driver part and a model information generation unit, the device driver part including one or more sets of model information including information of functions that can be requested to one or more devices, and support function information indicating information of the functions included in the one or more sets of model information, to execute an information processing method comprising:
generating, by the model information generation unit, second adding model information based on a comparison between first adding model information and the support function information,
wherein the first adding model information includes information of functions that can be executed in the device corresponding to a model to be added,
wherein the second adding model information is used for adding the model to be added that the device driver part can support, so that the device driver part can use a function of the model to be added, and
wherein the generated second adding model information includes information of the function of the model to be added so that the device driver part can request to use the function of a device of the model to be added.

10. A print system comprising:
a device driver part including one or more sets of model information including information of functions that can be requested to one or more devices;
one or more printing devices;
a support function information generation unit configured to generate the support function information based on the one or more sets of model information included in the device driver part, the support function information indicating information of the functions that can be requested by the device driver part;
a model information generation unit configured to generate second adding model information based on a comparison between first adding model information and the support function information,
wherein the first adding model information includes information of functions that can be executed in the device corresponding to a model to be added,
wherein the second adding model information is used for adding the model to be added that the device driver part can support, so that the device driver part can use a function of the model to be added, and
wherein the generated second adding model information includes information of the function of the model to be added so that the device driver part can request to use the function of the device of the model to be added; and
a print unit configured to generate print data from data to be printed based on the model information or the second adding model information.
